(19) United States
(12) Patent Application Publication
(10) Pub. No.: US 2016/0378909 A1
(43) Pub. Date: Dec. 29, 2016

(54) PROCESS FOR IDENTIFYING CULTURE CONDITIONS FOR A CELL OR ORGANISM

(71) Applicant: GLAXOSMITHKLINE BIOLOGICALS SA, Rixensart (BE)

(72) Inventors: Philippe Marc Helene DEHOTTAY, Rixensart (BE); Philippe GOFFIN, Rixensart (BE); Bas TEUSINK, Amsterdam (NL); Filipe BRANCO DOS SANTOS, Amsterdam (NL)

(73) Assignee: GLAXOSMITHKLINE BIOLOGICALS SA, Rixensart (BE)

(21) Appl. No.: 15/104,393

(22) PCT Filed: Dec. 15, 2014
(86) PCT No.: PCT/IB2014/066912

§ 371 Date: Jun. 14, 2016

(30) Foreign Application Priority Data
Dec. 17, 2013 (GB) 1322303.7

(51) Int. Cl. G06F 19/12

(52) U.S. Cl. CPC G06F 19/12

(57) ABSTRACT

Methods for identifying culture conditions for a cell, the method comprising: (a) obtaining a genome scale stoichiometric metabolic model of the cell, and (b) performing constraint based optimization on the metabolic model of the cell using at least one yield based constraint.

### BACKGROUND

The present invention relates to production processes for cells and materials obtained therefrom.

Metabolic models for various organisms are known and can be used to develop commercial production processes. The present invention addresses the issue of improvements over existing metabolic models.

### SUMMARY OF THE INVENTION

An aspect of the present invention relates to a method for identifying culture conditions for a cell or organism, the method comprising: (a) obtaining a genome scale stoichiometric metabolic model of the cell or organism, and (b) performing constraint based optimization on the metabolic model of the cell or organism using at least one yield based constraint, wherein the yield based constraint promotes a condition identified as promoting a kinetic parameter and/or suppressing a condition that has been identified as inhibiting a kinetic parameter so as to improve culture conditions for both yield and the kinetic parameter.

A further aspect of the present invention is a method for growth of a cell or organism, the method comprising growing the cell or organism under said culture conditions identified by a method for identifying culture conditions as described herein, optionally measuring kinetic parameters, and applying said kinetic parameters so obtained to further optimise the culture conditions.

A further aspect of the present invention is a system comprising a processor and a memory arranged to store computer executable instructions, which when executed cause the processor to perform constraint based optimisation on a metabolic model of a cell or organism using at least one yield based constraint, wherein the yield based constraint promotes a condition identified as promoting a kinetic parameter and/or suppressing a condition that has been identified as inhibiting a kinetic parameter, so as to improve culture conditions for both yield and the kinetic parameter.

### BRIEF DESCRIPTION OF THE DRAWINGS

FIG. 1 schematically illustrates components of an exemplary computing-based device which may be used in implementing the present invention.

### DETAILED DESCRIPTION

In a first aspect of the present invention, constraint-based optimisation (specifically flux based optimisation) has been performed on a metabolic model of a cell using at least one yield based constraint, wherein the yield based constraint promotes a condition identified as promoting a kinetic parameter and/or suppressing a condition that has been identified as inhibiting that kinetic parameter so as to improve culture conditions for both yield and the kinetic parameter.

One example of a kinetic parameter is growth rate. Therefore the invention also relates to a method for identifying culture conditions for a cell or organism, the method comprising: obtaining a genome scale stoichiometric metabolic model of the cell or organism and performing constraint based optimisation on the metabolic model of the cell or organism using at least one yield based constraint, wherein the yield based constraint promotes a condition identified as promoting growth rate and/or suppressing a condition that has been identified as inhibiting growth rate so as to improve culture conditions for both yield and growth rate.

Flux based optimisation is generally applied to optimise yield without consideration of kinetic parameters such as growth rate, because there is no kinetic information in the stoichiometric metabolic model.

Particular compounds or parameters either promoting or inhibiting growth rate of certain bacterial species have been identified which can be used to narrow down the solutions (or set of solutions) for yield optimization under a given set of constraints. Thus, in comparison with known modelling methods based on yield, the present invention allows additional narrowing of a possible solution space to flux distributions with optimised kinetic parameters.

In one aspect the kinetic parameter is a rate, for example, for example is growth rate, rate of metabolite production or consumption, rate of gene expression rate of recombinant protein productionor rate of recombinant protein secretion. For the avoidance of doubt, the term ‘kinetic parameter’ is used herein in the broadest sense as any property that is not stoichiometric.

Growth rate may be determined by, for example, measurement of optical density. Protein production may be determined by e.g. ELISA or other well known techniques. Gene expression may be monitored by, for example, RNA expression. High throughput methods such as those described in Example 3 may be used. All rate measurements are measured as a function of time.

In Example 4 data is shown in respect of improving both yield and growth rate according to the present invention.

In Example 5 which relates to PT production the solution space is constrained so that negative transcriptional regulatory effects are minimized, and hence, flux balance analysis (FBA) can only identify solutions that result in the desired biomass yield (this is constrained to the desired value) while minimizing negative regulatory effects on genes for PT expression. This example illustrates a general method for optimizing properties that are not explicitly taken into account in a model, by converting these properties into constraints so that the solution space is restricted to solutions that meet these constraints, and therefore also meet these additional, non-explicit “objectives” (e.g. rate, protein, toxin production, etc).

The invention uses a yield based constraint identified as promoting a kinetic parameter. Such constraints may be identified by high-throughput cultivation ssays or low-throughput, reading articles, performing (comparative) transcriptomics/proteomics/metabolomics analysis, retrieving information from (public) databases.

More generally, the present invention relates to a method for optimisation of kinetic properties with purely stoichiometric models, by incorporating knowledge about such properties in the form of constraints.

The yield referred to in the present invention may be the yield of a cell or yield of a cellular component such as a particular protein or peptide or carbohydrate or nucleic acid.

Any suitable method may be used to measure yield. For example, for biomass yield, suitable methods include optical density, wet cell weight, dry cell weight colony forming units, or particle counts (with FACS or microscopy, with different dyes, etc.). For the yield of a particular protein, suitable methods can include ELISA, densitometry on SDS-PAGE (eg with different stains), MS-based methods, HPLC or UPLC (with different detection methods.)

In one aspect the claimed invention for identifying culture conditions for a cell or organism may be implemented on a computer. As such the invention relates to a system comprising:

A processer; and

A memory arranged to store computer executable instructions, which when executed cause the processor to perform constraint based optimisation on a metabolic model of a cell or organism using at least one yield based constraint, wherein the yield based constraint promotes a condition identified as promoting a kinetic parameter and/or suppressing a condition that has been identified as inhibiting a kinetic parameter, so as to improve culture conditions for both yield and the kinetic parameter.

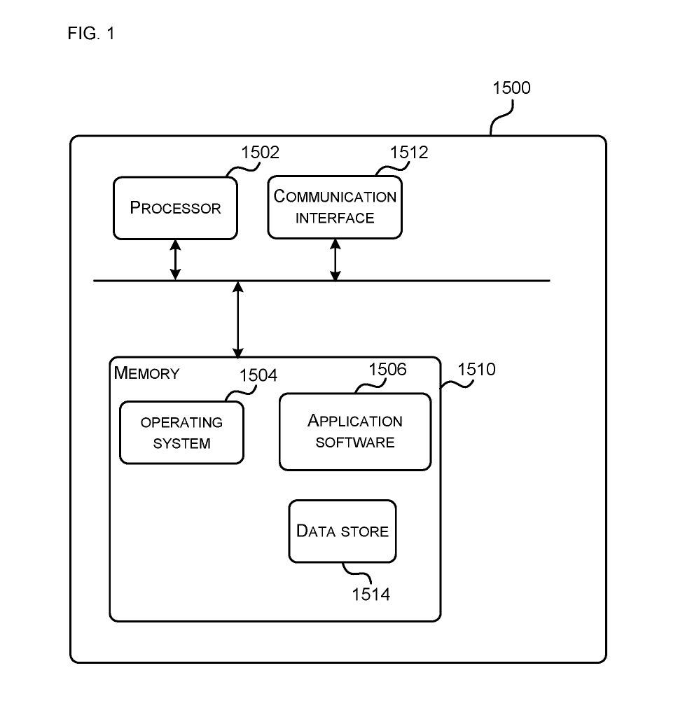

FIG. 1 illustrates various components of an exemplary computing-based device which may be implemented as any form of a computing and/or electronic device, and in which embodiments of the invention may be implemented.

Computing-based device comprises one or more processors which may be microprocessors, controllers or any other suitable type of processors for processing computer executable instructions to control the operation of the device in order to perform constraint based optimisation on a metabolic model of a cell or organism using at least one yield based constraint, wherein the yield based constraint promotes a condition identified as promoting a kinetic parameter and/or suppressing a condition that has been identified as inhibiting a kinetic parameter, so as to improve culture conditions for both yield and the kinetic parameter.

In some examples, for example where a system on a chip architecture is used, the processors may include one or more fixed function blocks (also referred to as accelerators) which implement a part of the method of performing the constraint based optimisation in hardware (rather than software or firmware). Platform software comprising an operating system or any other suitable platform software may be provided at the computing-based device to enable application software to be executed on the device.

The computer executable instructions may be provided using any computer-readable media that is accessible by the computing based device. Computer-readable media may include, for example, computer storage media such as memory and communications media. Computer storage media, such as memory, includes volatile and non-volatile, removable and non-removable media implemented in any method or technology for storage of information such as computer readable instructions, data structures, program modules or other data.

Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media is shown within the computing-based device it will be appreciated that the storage may be distributed or located remotely and accessed via a network or other communication link.

The computing-based device also suitably comprises an input/output controller arranged to output display information to a display device which may be separate from or integral to the computing-based device. The display information may provide a graphical user interface. The input/output controller is also arranged to receive and process input from one or more devices, such as a user input device (e.g. a mouse or a keyboard). This user input may be used to input information to enable the constraint based optimisation to be performed on a metabolic model of a cell or organism using at least one yield based constraint.

In an embodiment the display device may also act as the user input device if it is a touch sensitive display device. The input/output controller may also output data to devices other than the display device, e.g. a locally connected printing device (not shown in FIG. 1).]

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The method of the invention uses constraint based optimisation on a metabolic model.

Constraint-based modelling procedures do not strive to find a single solution but rather find a collection of all allowable solutions to the governing equations that can be defined. Solutions that violate any of the imposed constraints are excluded from the collection, which mathematically is called a solution space. The subsequent application of additional constraints further reduces the solution space and, consequently, reduces the number of allowable solutions that a cell can utilize. The constraints that have been used in the first generation of constraint-based models include stoichiometric constraints (mass balance), thermodynamic constraints (regarding the reversibility of a reaction), and enzymatic capacity constraints.

Metabolic models are described in “Orth J D, Fleming R M T, Palsson BØ. 2010. Reconstruction and Use of Microbial Metabolic Networks: the Core Escherichia coli Metabolic Model as an Educational Guide. In Curtiss R, III, KaperJ B, Squires C L, Karp P D, Neidhardt F C, Slauch J M (ed.), EcoSal. Such models are also described in Santos et al, “Methods in Enzymology, Volume 500 # 2011 Elsevier Inc ISSN 0076-6879, DOI: 10.1016/B978-0-12-385118-5.00024-4”.

Constraint based optimisation may be Flux based analysis (FBA). Flux based analysis is generally designed for yield optimization. In a stoichiometric network with no information about kinetics, rate prediction is impossible using flux based analysis. After the application of constraints (which reduce the solution space), an optimization method (such as FBA) is applied to look for a single solution (FBA) or a set of solutions (typically, using flux variability analysis (FVA)) within the solution space, which maximizes or minimizes an objective function (which can be a single flux, for instance, biomass production), or a combination of several fluxes).

Other constraint based optimisation methods that may be considered in the present invention are discussed in Lewis et al. Nat. Microbiol. Rev. 10:291 (2012), incorporated herein by reference (See e.g. FIG. 2 of Lewis et al.)

In flux based analysis constraints are applied on the different reactions of the model, i.e. the minimum and maximum possible flux through each reaction. Reactions in the model can be divided into two main categories, and therefore the type of constraints that will be applied will differ, as described below.

Internal reactions, i.e. all reactions that are inside the system (note that this also includes transport reactions from the outside to the inside of the cell (and the other way round), and extracellular reactions). These reactions are the (bio)chemical reactions that connect metabolites together.

In one aspect no constraints are set on these internal reactions. In one aspect some reactions may be defined as irreversible (mainly from a thermodynamic point of view), which is reflected by a lower boundary equal to 0 and an upper boundary equal to infinity (e.g. practically, this will be +99999). In one aspect, e.g. for reversible reactions, the lower boundary will be set to infinitely low e.g. −99999 and the upper boundary infinitely high e.g. to +99999.

In one aspect, if the aim is to simulate the effects of the absence of a reaction (gene knock-out for instance), the lower and upper boundaries are both set to 0.

Exchange reactions, i.e. a relatively small number of reactions (about 202 in the pertussis model) that determine which compounds are allowed in and out of the system. In other words, which compounds can be produced and consumed.

Preferably the constraint based modelling is applied to such exchange and/or internal reactions.

By convention, uptake (consumption) is defined as negative flux, while excretion (production) is defined as positive flux.

In one aspect where a specific compound is to be consumed, i.e. it is not wanted in the medium composition but can be produced, the lower boundary is set to 0 and the upper boundary to +99999. The upper boundary can also be set to any specific number between 0 and +99999, reflecting the maximum production flux allowed for this compound. In other words, where it does not matter if a compound is produced, the upper boundaries may be set to be infinitely high.

In one aspect a specific compound is consumed and not produced, both the lower and upper boundaries can be set to 0.

In one aspect where a specific compound is to be consumed (i.e. it is considered it as part of the medium composition) but is not to be produced, the lower boundary is set to the maximum concentration allowed in the medium composition (for instance, if there is a desired maximum of 125 mM L-glutamate in the medium, the lower boundary will be set as −125), and the upper boundary is set to 0 (no production allowed). Such a constraint will not force the model to identify solutions where the compound is actually consumed. To do so the upper boundary may be set to −125 as well (for the L-glutamate example).

If a specific compound is to be consumed, and also produced, the lower boundary may be set to −99999 and the upper boundaries to +99999 (or any specific number, if a maximum level of consumption/production is to be tolerated).

Generally, in summary, to force the model to identify solutions where a specific compound is consumed (for instance because it has a positive effect on the growth rate), the upper boundary for the corresponding flux may be set to any number smaller than 0 and bigger than or equal to the lower boundary.

Conversely, to exclude a specific compound from the medium composition (e.g. because it has a negative effect on the growth rate), the lower boundary may be set to any number equal to or bigger than 0.

As an example: For B pertussis, and in comparison to a minimally identified medium, L-Arginine has a positive effect on growth rate. It is desired that the model identifies solutions where at least 2 mM L-Arg is consumed, and only a maximum of 100 mM L-Arg in the medium can be provided. In this situation the lower bound set to −100, upper bound set to −2. The application of constraint-based optimization under a given set of constraints results in a solution (if feasible) where L-Arg uptake flux is between 2 and 100 mM.

As another example: for B pertussis and in comparison to a minimally identified medium L-Isoleucine has a negative effect on growth rate. It is desired no L-Ile be consumed, and that it is not be produced. Lower bound set to 0, upper bound set to 0. The model will then propose (if feasible) solutions where L-Ile is neither taken up nor produced.

A condition identified as promoting a kinetic parameter (eg growth rate) or a condition which inhibits a kinetic parameter (eg growth rate) may be the presence or absence a compound or set of compounds.

Compounds may be, for example, amino acids, vitamins, minerals, metals or any components of standard growth media.

Compounds may be any compound or combination of compounds as disclosed herein, such as (but not limited to) Adenine, Biotin, pantothenate, calcium, Choline, citrate, cobalt, Folate, Glycine, Glycerol, Guanine, borate, Haemin, Inositol, Alanine, Arginine, Asparagine, Aspartate, Cysteine, Glutamine, Histidine, Isoleucine, Leucine, Lysine, Methionine, Phenylalanine, Proline, Serine, Threonine, Tryptophane, Tyrosine, Valine, magnesium, manganese, acetate, beta-hydroxybutyrate, formate, Lactate, pyruvate, 2-ketoglutarate, Fumarate, phosphate, NAD, bicarbonate, ammonia, para-aminobenzoic acid, Potassium iodide, Pyridoxine, Riboflavin, Succinic acid, Sucrose, Thiamine, Uracil, zinc, chloride, sulphate, sodium. In one aspect such compounds are for use in Pertussis models and growth media.

In another aspect a condition promoting a kinetic parameter or inhibiting a kinetic parameter may be gas supply, such as oxygen or carbon dioxide supply, or proton availability/acidity.

In one aspect the condition is the inclusion of a compound or set of compounds known to promote a kinetic parameter, optionally having an upper maximum concentration.

In one aspect the growth condition promotes the kinetic parameter without any negative effect on yield. In one aspect the yield is not affected by more than 5% or 10% in comparison with growth or prediction without the growth condition.

In one aspect the growth condition promotes both the kinetic parameter and yield.

In one aspect reference to a condition that promotes a kinetic parameter is a condition measured with respect to a kinetic parameter in the same media but without the condition. For example, addition of a specific compound such as glycine to a media may demonstrate a faster growth than the same media without glycine.

In one aspect the kinetic parameter is considered with respect to a chemically defined medium which may be a minimal media. A minimal media may be any media that contains only a minimal set of components need for cell growth, but also may refer to a media in which the addition of an additional component can improve growth and which is therefore not an optimal growth media. A minimal media may also be considered as a media that supports sub-optimal growth.

In one aspect a condition that promotes a kinetic parameter or that suppresses a condition that has been identified as inhibiting a kinetic parameter such as growth rate has been identified by a comparison of the kinetic parameter in media such as minimal media with and without the condition.

In one aspect the cell or organism is a single celled organism such as a yeast or bacteria, and in one aspect is a bacteria, such as B. pertussis. In one embodiment the Bordetella species is selected from the group consisting of Bordetella pertussis, Bordetella parapertussis, or Bordetella bronchiseptica. In one embodiment the Bordetella species is Bordetella pertussis. In one embodiment the Bordetella species expresses at least one virulence factor selected from the group consisting of Pertussis Toxin (PT), Filamentous Haemagglutinin (FHA), and Pertactin (PRN). In one embodiment the Bordetella species expresses PT, in one embodiment the Bordetella species expresses FHA, in one embodiment the Bordetella species expresses PRN, in one embodiment the Bordetella species expresses PT and FHA, in one embodiment the Bordetella species expresses PT and PRN, in one embodiment the Bordetella species expresses PRN and FHA, in one embodiment the Bordetella species expresses PT, PRN and FHA. PT, FHA and PRN are well known in the art. Pertussis Toxin may refer to a toxin or a genetically altered Pertussis Toxoid.

Other suitable cells or organisms include prokaryotic or eukaryotic cells such as Escherichia coli, Staphylococcus aureus, Streptococcus pneumoniae, Haemophilus influenzae, Clostridium difficile and Neisseria meningitidis, Saccharomyces cerevisiae, Pichia pastoris, Hansenula polymorpha, Pseudomonas fluorescens, Bacillus subtilis, and eukaryotic cell lines such as CHO, VERO, MRCS, HEK293, EB66, or insect cells.

In one aspect, for B. pertussis, the growth condition is the presence of a compound below, at a concentration of 0.01-100 mM, such as 0.01-90 mM, 0.01-80 mM, 0.01-70 mM, 0.01-60 mM, 0.01-50 mM, 0.01-40 mM, 0.01-30 mM, 0.01-20 mM, 0.01-10 mM, such as 9, 8, 7, 6, 5, 4, 3, 2 or 1 mM. Suitable compounds include CaCl₂.2H₂O (optionally at 0.3 mM), glycine (optionally at 2 mM), haemin (optionally at 50 mg/L), L-alanine (optionally at 2 mM), L-histidine (optionally at 2 mM), L-proline (optionally at 2 mM), sodium L-lactate (optionally at 5 mM), NaHCO₃ (optionally at 2 mM), para-aminobenzoic acid (optionally at 0.2 mg/L), and riboflavin (optionally at 0.01-100 mg/L, such as 90, 80, 70, 60, 50, 40, 30 20 10, 9, 8, 7, 6, 5, 4, 3, 2, 1 or 0.5 or 0.4 mg/L such as 0.3 mg/L). Such conditions may be suitable to promote growth rate without affecting yield

In one aspect, for B pertussis, the growth condition may promote both growth rate and yield. Optionally the growth condition may be is the presence of a compound selected from biotin (optionally at 0.02 mg/L), glycine (optionally at 20 mM), L-alanine (optionally at 20 mM), L-arginine (optionally at 2 and/or 20 mM), L-cysteine (optionally at 2 and/or 20 mM), L-methionine (optionally at 2 and/or 20 mM), L-proline (optionally at 20 mM), MgCl₂.6H₂O (optionally at 10 mM), NaHCO₃ (optionally at 20 mM), and thiamine (optionally at optionally at 0.01-100 mg/L, such as 90, 80, 70, 60, 50, 40, 30, 20 mg/L such 10 mg/L).

The present invention also includes both a method for identification of culture conditions for growing a cell or organism, and a method using those conditions comprising growing the cell or organism under culture conditions identified according to the method for identifying culture conditions, and optionally further recovering cells of the organism or a product derived therefrom.

Growth may be an industrial scale fermentation process, using a medium as described herein, where the process comprises providing an inoculum of a cell or organism and incubating the inoculum in a chemically defined medium, where the fermentation is allowed to proceed for a time sufficient for the bacteria to reproduce

The present invention also includes a method as disclosed herein additionally comprising growing the organism under said identified culture conditions and measuring growth parameters, and using the measured growth parameters to allow optimisation of a model used to predict the culture conditions.

The present invention also relates to the use of one or more of the following compounds in the preparation of a chemically defined media for growth of B. pertussis, optionally in the supplementation of a minimal media for B pertussis, optionally the media of Example 1:

CaCl₂.2H₂O (optionally at 0.3 mM), glycine (optionally at 2 mM), haemin (optionally at 50 mg/L), L-alanine (optionally at 2 mM), L-histidine (optionally at 2 mM), L-proline (optionally at 2 mM), sodium L-lactate (optionally at 5 mM), NaHCO₃ (optionally at 2 mM), para-aminobenzoic acid (optionally at 0.2 mg/L), and riboflavin (optionally at 0.01-100 mg/L, such as 90, 80, 70, 60, 50, 40, 30 20 10, 9, 8, 7, 6, 5, 4, 3, 2, 1 or 0.5, 0.4 mg/L such as 0.3 mg/L); biotin (optionally at 0.02 mg/L), glycine (optionally at 20 mM), L-alanine (optionally at 20 mM), L-arginine (optionally at 2 and/or 20 mM), L-cysteine (optionally at 2 and/or 20 mM), L-methionine (optionally at 2 and/or 20 mM), L-proline (optionally at 20 mM), MgCl₂.6H₂O (optionally at 10 mM), NaHCO₃ (optionally at 20 mM), and thiamine (optionally at optionally at 0.01-100 mg/L, such as 90, 80, 70, 60, 50, 40, 30, 20 mg/L such 10 mg/L).

Optionally the method of the invention is designed to identifying culture conditions for a cell or organism (in one embodiment this is B. pertussis) in which a condition promoting a kinetic parameter such as growth rate and/or suppressing a condition that has been identified as inhibiting a kinetic parameter such as growth rate is established in comparison to a chemically defined media (CDM).

In one embodiment the process further comprises purifying a virulence factor, e.g. from B pertussis, to produce a purified virulence factor. The purified virulence factor may be a purified Pertussis Toxin (PT), Filamentous Haemagglutinin (FHA), Pertactin (PRN), agglutinogen 2 or agglutinogen 3. The purified virulence factor may be altered after purification, for example Pertussis Toxin may be chemically detoxified after purification. See also EP 427462 and WO 91/12020 for the preparation of pertussis antigens. In an embodiment purification involves cell purification using chromatography. In an embodiment the chromatography technique is affinity chromatography, gel filtration, high pressure liquid chromatography (HPLC) or ion exchange chromatography. Optionally the affinity chromatography uses an affinity tag purification column, an antibody purification column, a lectin affinity column, a prostaglandin purification column or a strepavidin column. Optionally the HPLC uses an ion exchange column, a reverse phase column or a size exclusion column. Optionally the ion exchange column is an anion exchange column or a cation exchange column.

In one embodiment the process further comprises a step of formulating an immunogenic composition comprising a component produced using the method of the invention (such as a purified virulence factor).

In one embodiment the process further comprises a further step of adding at least one antigen to the immunogenic composition. In one embodiment the at least one antigen is selected from the group consisting of Pertussis Toxin, Filamentous Haemaglutinin, Pertactin, a Fimbrial Agglutinogen, Diphtheria Toxoid, Tetanus Toxoid, at least one saccharide antigen from N. meningitidis, Hepatitis B surface antigen, Inactivated Polio Virus (IPV) and a saccharide antigen from Haemophilus influenzae b (optionally conjugated to Tetanus Toxoid). The at least one saccharide antigen from N. meningitidis may be MenC, MenY, MenA and MenW (e.g. A+C, A+Y, A+W, C+Y, C+W, Y+W, A+C+Y, A+C+W, A+Y+W, C+Y+W, A+C+Y+W); optionally MenC and/or MenY is included, optionally all four are included.

Alternatively or in addition to the above meningococcal antigens, the immunogenic composition may comprise one or more pneumococcal capsular oligosaccharide or polysaccharide—carrier protein conjugates (see above for carrier proteins comprising T-helper epitopes, such as CRM197, diphtheria toxoid, tetanus toxoid or protein D).

Typically pneumococcal capsular oligosaccharides or polysaccharides represented in the compositions of the invention comprise antigens derived from at least four serotypes of pneumococcus, such as serotypes 6B, 14, 19F and 23F. Alternatively, at least 7 serotypes are comprised in the composition, for example those derived from serotypes 4, 6B, 9V, 14, 18C, 19F, and 23F. Alternatively, at least 11 serotypes are comprised in the composition (11 valent), for example those derived from serotypes 1, 3, 4, 5, 6B, 7F, 9V, 14, 18C, 19F and 23F. In one embodiment of the invention at least 13 of such conjugated pneumococcal antigens are comprised, although further antigens, for example 23 valent (such as serotypes 1, 2, 3, 4, 5, 6B, 7F, 8, 9N, 9V, 10A, 11A, 12F, 14, 15B, 17F, 18C, 19A, 19F, 20, 22F, 23F and 33F), are also contemplated by the invention.

In one embodiment the immunogenic composition comprises a pharmaceutically acceptable excipient.

In one embodiment the immunogenic composition comprises an adjuvant such as aluminium phosphate or aluminium hydroxide. Methods of adsorbing DTPa and DTPw antigens onto aluminium adjuvants are known in the art. See for example WO 93/24148 and WO 97/00697. Usually components adsorbed onto adjuvant are left for a period of at least 10 minutes at room temperature at an appropriate pH for adsorbing most or all of the antigen before mixing the antigens together in the combination immunogenic compositions of the present invention.

Other components may be unadsorbed (such as IPV) or adsorbed specifically onto other adjuvants. For example Hepatitis B surface antigen (HepBsa) may be adsorbed onto aluminium phosphate (as described in WO 93/24148) before mixing with other components.

In a further embodiment there is provided a virulence factor obtainable by the process. In a further embodiment there is provided a virulence factor obtained by the process.

In a further embodiment there is provided an immunogenic composition comprising the virulence factor and a pharmaceutically acceptable excipient. In one embodiment the immunogenic composition comprises at least one further antigen. In one embodiment the at least one antigen is selected from the group consisting of Pertussis Toxin, Filamentous Haemaglutinin, Pertactin, a Fimbrial Agglutinogen, Diphtheria Toxoid, Tetanus Toxoid, at least one saccharide antigen from N. meningitidis, Hepatitis B surface antigen, Inactivated Polio Virus (IPV) and a saccharide antigen from Haemophilus influenzae b (optionally conjugated to Tetanus Toxoid). The at least one saccharide antigen from N. meningitidis may be MenC, MenY, MenA and MenW (e.g. A+C, A+Y, A+W, C+Y, C+W, Y+W, A+C+Y, A+C+W, A+Y+W, C+Y+W, A+C+Y+W); optionally MenC and/or MenY is included, optionally all four are included. In one embodiment the vaccine comprises diphtheria toxoid, tetanus toxoid, and at least one of PT, FHA and PRN (a DTPa vaccine).

In one embodiment the immunogenic composition comprises aluminium phosphate or aluminium hydroxide. Methods of adsorbing DTPa antigens onto aluminium adjuvants are known in the art. See for example WO 93/24148 and WO 97/00697. Usually components adsorbed onto adjuvant are left for a period of at least 10 minutes at room temperature at an appropriate pH for adsorbing most or all of the antigen before mixing the antigens together in the combination immunogenic compositions of the present invention.

Other components may be unadsorbed (such as IPV) or adsorbed specifically onto other adjuvants. For example, Hepatitis B surface antigen (HepBsa) may be adsorbed onto aluminium phosphate (as described in WO 93/24148) before mixing with other components.

In one embodiment there is a provided a vaccine comprising the immunogenic composition.

Vaccine preparation is generally described in Vaccine Design—The Subunit and adjuvant approach Ed Powell and Newman; Pellum Press. Advantageously the combination vaccine according to the invention is a paediatric vaccine.

The content of protein antigens in the vaccine will typically be in the range 1-100 μg or 5-50 μg, most typically in the range 5-25 μg.

A sufficient amount of antigen for a particular vaccine can be ascertained by standard studies involving observation of antibody titres and other responses in subjects. Following an initial vaccination, subjects may receive one or two booster injections at about 4 weeks intervals or longer.

The vaccine preparations of the present invention may be used to protect or treat mammalian (including human) subjects susceptible to infection, by means of administering said vaccine via systemic or mucosal route. These administrations may include injection via the intramuscular, intraperitoneal, intradermal or subcutaneous routes; or via mucosal administration to the oral/alimentary, respiratory, genitourinary tracts.

In a further aspect there is provided the immunogenic composition or the vaccine for use in the prevention or treatment of disease.

In a further aspect there is provided the immunogenic composition or the vaccine of claim for use in the prevention or treatment or Bordetella pertussis disease.

In a further aspect there is provided a use of the immunogenic composition or the vaccine in the prevention or treatment of disease.

In a further aspect there is provided a use of the immunogenic composition or the vaccine in the preparation of a medicament for the treatment or prevention of bacterial disease.

In a further aspect there is provided a method of preventing or treating disease comprising administering the immunogenic composition or the vaccine as described herein to a subject.

In one embodiment the disease is Bordetella pertussis disease.

In one embodiment the disease is Bordetella pertussis disease, and the subject is a human.

Unless otherwise explained, all technical and scientific terms used herein have the same meaning as commonly understood by one of ordinary skill in the art to which this disclosure belongs. Definitions of common terms in molecular biology can be found in Benjamin Lewin, Genes V, published by Oxford University Press, 1994 (ISBN 0-19-854287-9); Kendrew et al. (eds.), The Encyclopedia of Molecular Biology, published by Blackwell Science Ltd., 1994 (ISBN 0-632-02182-9); and Robert A. Meyers (ed.), Molecular Biology and Biotechnology: a Comprehensive Desk Reference, published by VCH Publishers, Inc., 1995 (ISBN 1-56081-569-8).

Standard three-letter abbreviations are used herein in referring to amino acids, e.g., Glu for Glutamic acid, Cys for cysteine, Ser for Serine, Met for Methionine, etc. Amino acids are the L form optical isomer, unless specifically noted to be the D form. Standard abbreviations are used to refer to chemical compounds, e.g., Na+ for sodium ion, H₂PO₄⁻ for dihydrogen phosphate ion; Ca²⁺ for calcium ion, Fe²⁺ for iron ion, K+ for potassium ion, and Mg²⁺ for magnesium ion. Such ions may be provided by inorganic salts.

The singular terms “a,” “an,” and “the” include plural referents unless context clearly indicates otherwise. Similarly, the word “or” is intended to include “and” unless the context clearly indicates otherwise. The term “plurality” refers to two or more. It is further to be understood that all base sizes or amino acid sizes, and all molecular weight or molecular mass values, given for nucleic acids or polypeptides are approximate, and are provided for description. Additionally, numerical limitations given with respect to concentrations or levels of a substance, such as an antigen, are intended to be approximate. Thus, where a concentration is indicated to be at least (for example) 200 pg, it is intended that the concentration be understood to be at least approximately (or “about” or “~”) 200 pg.

Although methods and materials similar or equivalent to those described herein can be used in the practice or testing of this disclosure, suitable methods and materials are described below. The term “comprises” means “includes.” Thus, unless the context requires otherwise, the word “comprises,” and variations such as “comprise” and “comprising” will be understood to imply the inclusion of a stated compound or composition (e.g., nucleic acid, polypeptide, antigen) or step, or group of compounds or steps, but not to the exclusion of any other compounds, composition, steps, or groups thereof. The abbreviation, “e.g.” is derived from the Latin exempli gratia, and is used herein to indicate a non-limiting example. Thus, the abbreviation “e.g.” is synonymous with the term “for example.”

### EXAMPLES

### Example 1

### Construction of a Genome-Scale Stoichiometric Metabolic Model for Bordetella pertussis Tohama I

The metabolic network of B. pertussis Tohama I was reconstructed based on its genome sequence (Parkhill et al., Nat. Genet. 35:32-40 (2003)) using standard methods that rely on available genome-scale metabolic models (Thiele and Palsson Nat. Protoc. 5:93-121 (2010) and Santos et al. Methods Enzymol. 500:509-532 (2011)). Due to phylogenetic proximity, the model iAF1260 of Escherichia coli MG1655 was used as a template (Feist et al. Mol. Syst. Biol. 3:121 (2007)). This initial automated draft reconstruction was then extensively manually curated, based on literature and newly obtained experimental data.

We started with the extensive characterization of the biomass composition and exometabolite fluxes at different growth stages in a reference controlled-batch experiment. This data was used to calibrate and refine the model through multiple iterative cycles of in silico simulations and experimentation, ultimately leading to model iBP1870. iBP1870 contains exchange reactions for 202 compounds—defining the potential for uptake and excretion of compounds—and 1,473 internal reactions, of which 1,017 are gene-associated, representing 762 genes (22% of genome). Important features include a detailed B. pertussis-specific biomass equation and many detailed, newly-defined reactions in pathways of amino acid metabolism, iron acquisition, sulfur metabolism, and biosynthesis of lipooligosaccharides and storage compounds.

Importantly, model iBP1870 does not contain explicit reactions for the production of toxins (such as PT) or adhesins (such as FHA or PRN). As a purely stoichiometric model, it does not contain information on reaction rates and gene expression regulation. Model iBP1870 was validated against previously published datasets (Thalen et al. J. Biotechnol. 75:147-159 (1999) and Thalen et al. Biologicals 34:289-297 (2006)): differences in growth yield observed in media containing various ratios of carbon and nitrogen sources were accurately reproduced in silico. The validated model can then be used to design de novo chemically defined growth medium based on the structure of the metabolic network and different optimization criteria.

### Example 2

### 20 L-Scale Fermentation of Bordetella pertussis in a Minimal De Novo Chemically Defined Medium

Given a validated genome-scale reconstruction of B. pertussis (see example 1), minimal growth requirements of B. pertussis (i.e. minimal sets of substrates that will allow B. pertussis to produce biomass) were determined. These minimal growth requirements were defined as the minimum number of active input fluxes (i.e. exchange fluxes used for the uptake of substrates). Among the different possible minimal sets of substrates identified, a single solution was arbitrarily selected, and used to formulate a de novo chemically defined medium (see composition in Table 1).

A first shake-flask pre-culture containing 7.5 ml fresh medium (MSS; derived from the medium of Stainer and Scholte. J. Gen. Microbiol. 63:211-220 (1971)) was inoculated with 10⁹ B. pertussis CFUs and incubated at 35° C. (+/−1° C.) and 150 rpm for 24 h (+/−1 h). The first pre-culture was used to inoculate a second shake-flask pre-culture containing 100 ml fresh medium (MSS). The second pre-culture was incubated at 35° C. (+/−1° C.) and 150 rpm for 24 h (+/−1 h), and used to inoculate two shake flasks each containing 1 L fresh medium (de novo minimal CDM; see composition in Table 1). After growth at 35° C. (+/−1° C.) and 150 rpm for 40 h (+/−4 h), the two shake-flasks from the third pre-culture were pooled. The pooled pre-culture was used to inoculate a fermentor as soon as the third pre-culture was stopped. A 20 L-fermentor (Biolafitte) was used. 10 L of medium were aseptically transferred into the fermentor. The following conditions were used in order to set the 100%-dissolved oxygen (DO) level: temperature (35° C.) and head pressure (0.4 bar). Inoculation was achieved by the addition of 1.5 L of the pooled pre-culture.

During the fermentation, the temperature (35° C.) and head pressure (0.4 bar) were maintained constant. Foaming was controlled by automatic addition of a polydimethylsiloxane emulsion via a foam controller. The air flow rate was kept constant at 20 NL/min. The level of dissolved oxygen was set at 25% and regulated by increasing stirring when the DO fell below 25%. The minimum stirring speed was set at 50 rpm. The pH was regulated at 7.2 by addition of acetic acid 50% (w/v).

The main fermentation data are summarized in Table 2.

TABLE 1
Composition of de novo minimal CDM.
All values in mg/L, except when stated otherwise.

| Compound | de novo minimal CDM |
|---|---|
| Na-L-Glutamate | 20,000 |
| KH₂PO₄ | 500 |
| KCl | 200 |
| MgCl₂•6H₂O | 100 |
| CaCl₂•2H₂O | 20 |
| Fe(III)-citrate•3H₂O | 10 |
| Tris | 6,100 |
| Ascorbic acid | 1,070 |
| Reduced Glutathione (GSH) | 400 |
| Niacin (nicotinic acid) | 4 |
| Dimethyl-β-cyclodextrin | 1,000 |
| L-Glutamic acid | 1,600 |
| Total C | 591.46 mM |
| Total N | 119.53 mM |
| Total S | 1.30 mM |

TABLE 2
Main fermentation parameters for B. pertussis
cultivated in de novo minimal CDM

| | COQ369 |
|---|---|
| Initial biomass (OD_{650 nm})* | 0.066 |
| Final biomass (OD_{650 nm}) | 7.7 |
| Biomass yield per mol C | 12.9 |
| (OD_{650 nm} mM_{C}⁻¹)** | |
| Biomass yield per mol N | 63.9 |
| (OD_{650 nm} mM_{N}⁻¹)** | |
| Biomass yield per mol S | 5865.2 |
| (OD_{650 nm} mM_{S}⁻¹)** | |
| Total fermentation time*** | 280 h 12 |
| Average generation time**** | 40.8 h |

*Initial biomass concentration calculated based on measured OD_{650 nm} of the pre-culture, i.e. 1.5*OD_{pre-culture}/11-5.
**Yields were calculated as the difference between OD_{650 nm} at the end of fermentation and OD_{650 nm} at the start of fermentation, divided by the concentration of C, N, or S in the medium, respectively.
***The total fermentation time is defined as the time at which oxygen consumption decreases (as a consequence of glutamate exhaustion), resulting in a decrease in stirring speed.
****Average generation time calculated as follows. First, the number of generations is calculated as the ratio between OD_{650 nm} at the end of fermentation and OD_{650 nm} at the start of fermentation, converted to log₂. The average generation time is then calculated by dividing the total fermentation time by the number of generations.

### Example 3

### High-Throughput Screening of Compounds That Modulate the Growth Behaviour of Bordetella pertussis

The de novo minimal CDM described in example 2 was used as a basis to screen for growth-modulating compounds, i.e. compounds that would affect either the growth rate or the growth yield of B. pertussis, or both.

A shake-flask containing 7.5 ml fresh medium (MSS containing 0.604 g/L niacin) was inoculated with 10⁹ B. pertussis CFUs and incubated at 35° C. (+/−1° C.) and 150 rpm for 24 h (+/−5 h). Cells were harvested by centrifugation, washed twice with NaCl 0.9% (w/v), and resuspended in fresh medium (de novo minimal CDM; see composition in Table 1) at a theoretical OD_{650 nm} of 0.5, as calculated from the OD_{650 nm} of the culture before harvest. 20 μl of this cell suspension were used to inoculate each well of a 96-well microtiter plate filled with 180 μl of de novo minimal CDM. To each of the wells, 20 μl of a supplement solution was added, which contained either of the compounds listed in Table 3. Only the inner wells of the plate were used for cultures, in order to minimize evaporation, and two controls were included, in which the supplement solution was replaced with water.

The plate was then incubated for 7 days at 35° C. in a Biotek Synergy H1 reader with constant shaking, and growth was automatically monitored every 10 minutes as OD_{650 nm}.

The entire procedure was repeated 7 times, in order to be able to screen a total of 56 compounds, each at two different concentrations, in 3 independent repeats.

For each supplement, the effect on the growth rate (defined as the average growth rate during the first generation, i.e. until OD_{650 nm} has doubled) and growth yield (defined as the maximum OD_{650 nm}) was calculated relative to the controls on the same plate. The relative growth yield and growth rate for each supplement was then averaged over the three independent repeats, and the standard deviation was calculated. Results are presented in Table 3.

TABLE 3
Results of high-throughput screening of growth-modulating compounds.

| | | | Relative yield | | Relative growth rate | |
|---|---|---|---|---|---|---|
| | Conc. in | | | Standard | | Standard |
| Supplement | medium | Unit | Average | deviation | Average | deviation |
| H₂O | N/A | N/A | 100.00% | 5.63% | 100.00% | 4.95% |
| Adenine | 0.1 | mg/L | 102.64% | 0.65% | 101.63% | 2.31% |
| Adenine | 1 | mg/L | 100.86% | 1.92% | 98.65% | 4.41% |
| Biotin | 0.02 | mg/L | 130.04% | 6.15% | 107.48% | 14.42% |
| Biotin | 0.2 | mg/L | 125.70% | 4.09% | 104.86% | 12.04% |
| Calcium | 1 | mg/L | 106.59% | 9.37% | 102.18% | 5.58% |
| pantothenate | | | | | | |
| Calcium | 10 | mg/L | 98.99% | 3.64% | 102.47% | 6.28% |
| pantothenate | | | | | | |
| CaCl₂•2H₂O | 0.3 | mM | 104.03% | 15.99% | 107.49% | 3.82% |
| CaCl₂•2H₂O | 3 | mM | 107.34% | 20.21% | 92.03% | 8.65% |
| Choline chloride | 0.6 | mg/L | 95.67% | 4.54% | 102.45% | 4.69% |
| Choline chloride | 6 | mg/L | 100.28% | 1.74% | 101.85% | 7.59% |
| Citric acid | 2 | mM | 83.46% | 5.44% | 57.76% | 11.82% |
| monohydrate | | | | | | |
| Citric acid | 20 | mM | 19.87% | 1.89% | 26.96% | 1.64% |
| monohydrate | | | | | | |
| CoCl₂•6H₂O | 0.42 | mg/L | 103.04% | 3.10% | 93.44% | 5.48% |
| CoCl₂•6H₂O | 4.2 | mg/L | 149.59% | 43.94% | 46.12% | 4.24% |
| Folate | 0.12 | mg/L | 106.78% | 10.55% | 101.07% | 5.69% |
| Folate | 1.2 | mg/L | 97.10% | 5.03% | 102.82% | 3.01% |
| Glycine | 2 | mM | 96.68% | 4.61% | 121.21% | 1.91% |
| Glycine | 20 | mM | 192.89% | 25.08% | 114.86% | 10.75% |
| Glycerol | 2 | mM | 99.99% | 7.21% | 102.01% | 11.03% |
| Glycerol | 20 | mM | 106.51% | 11.42% | 91.05% | 4.82% |
| Guanine | 0.1 | mg/L | 101.37% | 2.59% | 100.98% | 3.51% |
| Guanine | 1 | mg/L | 96.53% | 4.02% | 100.00% | 5.96% |
| H₃BO₃ | 2.36 | mg/L | 96.86% | 2.66% | 93.25% | 6.11% |
| H₃BO₃ | 23.6 | mg/L | 94.76% | 4.91% | 96.59% | 5.50% |
| Haemin | 5 | mg/L | 79.80% | 18.58% | 173.33% | 105.37% |
| Haemin | 50 | mg/L | 101.15% | 23.73% | 151.59% | 35.04% |
| Inositol | 2.8 | mg/L | 101.81% | 4.86% | 101.49% | 3.98% |
| Inositol | 28 | mg/L | 103.44% | 2.35% | 101.59% | 3.04% |
| L-Alanine | 2 | mM | 97.37% | 8.45% | 122.83% | 6.77% |
| L-Alanine | 20 | mM | 131.45% | 22.70% | 125.31% | 8.78% |
| L-Arginine | 2 | mM | 114.18% | 10.93% | 110.44% | 21.12% |
| L-Arginine | 20 | mM | 156.96% | 10.17% | 121.60% | 18.55% |
| L-Asparagine | 1.33 | mM | 97.99% | 5.11% | 100.61% | 5.10% |
| L-Asparagine | 13.3 | mM | 90.71% | 2.03% | 99.03% | 9.80% |
| L-Aspartate | 0.225 | mM | 106.30% | 10.27% | 96.87% | 6.69% |
| L-Aspartate | 2.25 | mM | 99.74% | 9.55% | 72.32% | 12.56% |
| L-Cysteine | 0.25 | mM | 157.51% | 24.62% | 154.78% | 16.23% |
| L-Cysteine | 2.5 | mM | 212.46% | 22.37% | 145.91% | 16.46% |
| L-Glutamine | 2 | mM | 99.74% | 4.97% | 104.98% | 9.72% |
| L-Glutamine | 20 | mM | 108.62% | 4.78% | 86.26% | 15.63% |
| L-Histidine | 2 | mM | 98.94% | 10.10% | 107.62% | 3.44% |
| L-Histidine | 20 | mM | 89.79% | 10.38% | 111.15% | 7.87% |
| L-Isoleucine | 2 | mM | 94.37% | 4.86% | 91.63% | 3.40% |
| L-Isoleucine | 20 | mM | 81.62% | 28.89% | 52.79% | 7.51% |
| L-Leucine | 1.33 | mM | 100.87% | 5.41% | 101.04% | 12.93% |
| L-Leucine | 13.3 | mM | 140.45% | 1.42% | 57.00% | 6.71% |
| L-Lysine HCl | 2 | mM | 108.70% | 10.44% | 88.93% | 0.28% |
| L-Lysine HCl | 20 | mM | 16.31% | 2.31% | 25.87% | 4.35% |
| L-Methionine | 2 | mM | 174.97% | 38.57% | 119.49% | 10.49% |
| L-Methionine | 20 | mM | 114.64% | 23.11% | 112.05% | 8.61% |
| L-Phenylalanine | 1.33 | mM | 90.14% | 5.34% | 76.48% | 6.97% |
| L-Phenylalanine | 13.3 | mM | 22.78% | 4.55% | 25.87% | 4.35% |
| L-Proline | 2 | mM | 97.41% | 6.70% | 138.48% | 33.70% |
| L-Proline | 20 | mM | 107.27% | 15.93% | 134.48% | 40.20% |
| L-Serine | 2 | mM | 86.25% | 5.65% | 104.57% | 16.75% |
| L-Serine | 20 | mM | 90.14% | 13.14% | 74.91% | 15.54% |
| L-Threonine | 2 | mM | 97.93% | 16.22% | 87.00% | 6.15% |
| L-Threonine | 20 | mM | 80.29% | 7.07% | 62.85% | 13.85% |
| L-Tryptophane | 0.518 | mM | 105.98% | 9.08% | 98.48% | 11.08% |
| L-Tryptophane | 5.18 | mM | 95.71% | 69.08% | 65.57% | 40.86% |
| L-Tyrosine | 0.0221 | mM | 96.91% | 3.09% | 97.58% | 6.60% |
| L-Tyrosine | 0.221 | mM | 96.52% | 0.79% | 94.80% | 3.08% |
| L-Valine | 2 | mM | 97.20% | 13.66% | 76.42% | 8.99% |
| L-Valine | 20 | mM | 29.05% | 15.11% | 26.79% | 5.85% |
| MgCl₂•6H₂O | 1 | mM | 102.26% | 11.83% | 99.38% | 6.72% |
| MgCl₂•6H₂O | 10 | mM | 222.99% | 36.49% | 106.39% | 5.41% |
| MnSO₄•H₂O | 1.89 | mg/L | 109.53% | 16.33% | 91.27% | 9.89% |
| MnSO₄•H₂O | 18.9 | mg/L | 91.55% | 47.94% | 47.58% | 32.48% |
| Sodium acetate | 5 | mM | 99.15% | 16.47% | 101.45% | 5.47% |
| Sodium acetate | 50 | mM | 152.20% | 18.54% | 71.40% | 6.66% |
| Sodium DL- | 2 | mM | 96.73% | 6.10% | 100.28% | 8.96% |
| beta- | | | | | | |
| hydroxybutyrate | | | | | | |
| Sodium DL- | 20 | mM | 145.46% | 26.90% | 94.37% | 9.56% |
| beta- | | | | | | |
| hydroxybutyrate | | | | | | |
| Sodium formate | 2 | mM | 143.35% | 54.91% | 97.36% | 13.94% |
| Sodium formate | 20 | mM | 168.28% | 8.37% | 89.12% | 7.82% |
| Sodium L- | 5 | mM | 100.70% | 11.39% | 128.73% | 22.20% |
| Lactate | | | | | | |
| Sodium L- | 50 | mM | 192.99% | 13.80% | 103.33% | 14.38% |
| Lactate | | | | | | |
| Sodium | 2 | mM | 92.03% | 13.41% | 77.63% | 9.98% |
| pyruvate | | | | | | |
| Sodium | 20 | mM | 147.17% | 21.46% | 45.86% | 4.44% |
| pyruvate | | | | | | |
| Disodium 2- | 2 | mM | 106.97% | 4.66% | 102.95% | 6.41% |
| ketoglutarate | | | | | | |
| Disodium 2- | 20 | mM | 194.83% | 11.21% | 103.67% | 10.01% |
| ketoglutarate | | | | | | |
| Disodium | 2 | mM | 107.14% | 9.07% | 97.72% | 9.68% |
| Fumarate | | | | | | |
| Disodium | 20 | mM | 171.26% | 14.85% | 86.72% | 14.97% |
| Fumarate | | | | | | |
| Na₂HPO₄ | 1 | mM | 105.07% | 6.54% | 99.98% | 3.61% |
| Na₂HPO₄ | 10 | mM | 230.29% | 20.92% | 101.26% | 8.22% |
| Na₂MoO₄•2H₂O | 0.94 | mg/L | 101.96% | 6.99% | 86.76% | 13.08% |
| Na₂MoO₄•2H₂O | 9.4 | mg/L | 105.65% | 6.13% | 91.79% | 12.74% |
| NAD | 10 | mg/L | 100.15% | 9.44% | 100.14% | 8.56% |
| NAD | 100 | mg/L | 104.61% | 5.31% | 97.38% | 7.08% |
| NaHCO₃ | 2 | mM | 102.33% | 11.15% | 108.83% | 1.90% |
| NaHCO₃ | 20 | mM | 171.17% | 12.61% | 131.94% | 4.76% |
| NH₄Cl | 1 | mM | 104.80% | 14.47% | 98.56% | 9.03% |
| NH₄Cl | 10 | mM | 119.35% | 8.18% | 85.00% | 4.55% |
| para- | 0.2 | mg/L | 99.47% | 4.61% | 105.14% | 3.91% |
| aminobenzoic | | | | | | |
| acid | | | | | | |
| para- | 2 | mg/L | 102.53% | 10.94% | 99.82% | 4.56% |
| aminobenzoic | | | | | | |
| acid | | | | | | |
| Potassium | 0.47 | mg/L | 101.89% | 9.16% | 94.69% | 7.40% |
| iodide | | | | | | |
| Potassium | 4.7 | mg/L | 104.26% | 8.03% | 99.91% | 4.33% |
| iodide | | | | | | |
| Pyridoxine | 0.2 | mg/L | 100.95% | 7.28% | 101.19% | 4.28% |
| Pyridoxine | 2 | mg/L | 97.66% | 5.35% | 101.12% | 7.28% |
| Riboflavin | 0.3 | mg/L | 98.12% | 9.19% | 106.38% | 4.56% |
| Riboflavin | 3 | mg/L | 97.90% | 4.70% | 103.60% | 4.42% |
| Succinic acid | 2 | mM | 88.42% | 9.86% | 56.67% | 12.27% |
| Succinic acid | 20 | mM | 19.82% | 2.25% | 26.96% | 1.64% |
| Sucrose | 6 | g/L | 110.72% | 6.44% | 95.27% | 5.20% |
| Sucrose | 60 | g/L | 193.22% | 17.49% | 58.15% | 2.33% |
| Thiamine HCl | 1 | mg/L | 99.82% | 6.66% | 104.29% | 3.47% |
| Thiamine HCl | 10 | mg/L | 108.94% | 8.72% | 108.35% | 4.78% |
| Uracil | 0.1 | mg/L | 97.30% | 3.33% | 98.35% | 5.99% |
| Uracil | 1 | mg/L | 100.94% | 5.24% | 94.82% | 8.24% |
| ZnCl₂ | 10 | mg/L | 179.38% | 24.51% | 103.27% | 6.52% |
| ZnCl₂ | 100 | mg/L | 130.71% | 26.13% | 56.44% | 6.15% |
| ZnSO₄•7H₂O | 1.89 | mg/L | 191.76% | 11.19% | 91.58% | 7.20% |
| ZnSO₄•7H₂O | 18.9 | mg/L | 163.55% | 23.00% | 99.13% | 4.43% |

Based on this high-throughput assay, the tested compounds can be classified as follows:

(I) Compounds with a positive effect (greater than 105.00%) on both the growth yield and growth rate. This category comprises biotin (0.02 mg/L), glycine (20 mM), L-alanine (20 mM), L-arginine (2 and 20 mM), L-cysteine (2 and 20 mM), L-methionine (2 and 20 mM), L-proline (20 mM), MgCl₂.6H₂O (10 mM), NaHCO₃ (20 mM), and thiamine (10 mg/L). These compounds should be included in the medium composition if growth yield and rate are to be improved.

(II) Compounds with a positive effect (greater than 105.00%) on the growth yield and no effect (between 95.00% and 105.00%) on the growth rate. This category comprises biotin (0.2 mg/L), calcium pantothenate (1 mg/L), folate (0.12 mg/L), L-aspartate (0.225 mM), L-tryptophane (0.518 mM), sodium formate (2 mM), sodium L-lactate (50 mM), disodium 2-ketoglutarate (2 and 20 mM), disodium fumarate (2 mM), Na₂HPO₄ (1 and 10 mM), sucrose (6 g/L), ZnCl₂ (10 mg/L), and ZnSO₄.7H₂O (18.9 mg/L). These compounds should be included in the medium composition if growth yield is to be improved without affecting the growth rate.

(III) Compounds with a positive effect (greater than 105.00%) on the growth yield and a negative effect (less than 95.00%) on the growth rate. This category comprises CaCl₂.2H₂O (3 mM), CoCl₂.6H₂O (4.2 mg/L), glycerol (20 mM), L-glutamine (20 mM), L-leucine (13.3 mM), L-lysine (2 mM), MnSO₄.H₂O (1.89 mg/L), sodium acetate (50 mM), sodium DL-beta-hydroxybutyrate (20 mM), sodium formate (20 mM), sodium pyruvate (20 mM), disodium fumarate (20 mM), Na₂MoO₄.2H₂O (9.4 mg/L), NH₄Cl (10 mM), sucrose (60 g/L), ZnCl₂ (100 mg/L), and ZnSO₄.7H₂O (1.89 mg/L). These compounds should be included in the medium composition if growth yield is to be improved, and a reduction in growth rate is required or can be tolerated.

(IV) Compounds with a negative effect (less than 95.00%) on both the growth yield and growth rate. This category comprises citric acid monohydrate (2 and 20 mM), L-isoleucine (2 and 20 mM), L-lysine (20 mM), L-phenylalanine (1.33 and 13.3 mM), L-serine (20 mM), L-threonine (20 mM), L-valine (20 mM), MnSO₄.H₂O (18.9 mg/L), sodium pyruvate (2 mM), and succinic acid (2 and 20 mM). These compounds should be included in the medium composition if a reduction in both the growth yield and growth rate is required or can be tolerated.

(V) Compounds with a negative effect (less than 95.00%) on the growth yield and no effect (between 95.00% and 105.00%) on the growth rate. This category comprises H₃BO₃ (23.6 mg/L), L-asparagine (13.3 mM), and L-serine (2 mM). These compounds should be included in the medium composition if a reduction in growth yield is required without affecting the growth rate.

(VI) Compounds with a negative effect (less than 95.00%) on the growth yield and a positive effect (greater than 105.00%) on the growth rate. This category comprises haemin (5 mg/L) and L-histidine (20 mM). These compounds should be included in the medium composition if growth rate is to be improved, and a reduction in growth yield is required or can be tolerated.

(VII) Compounds with no effect (between 95.00% and 105.00%) on the growth yield and a negative effect (less than 95.00%) on the growth rate. This category comprises CoCl₂.6H₂O (0.42 mg/L), H₃BO₃ (23.6 mg/L), L-aspartate (13.3 mM), L-threonine (2 mM), L-tryptophane (5.18 mM), L-tyrosine (0.221 mM), L-valine (2 mM), Na₂MoO₄.2H₂O (0.94 mg/L), and potassium iodide (0.47 mg/L). These compounds should be included in the medium composition if a reduction in growth rate is required without affecting the growth rate.

(VIII) Compounds with no effect (between 95.00% and 105.00%) on both the growth yield and growth rate. This category comprises adenine (0.1 and 1 mg/L), calcium pantothenate (10 mg/L), choline chloride (0.6 and 6 mg/L), folate (1.2 mg/L), glycerol (2 mM), guanine (0.1 and 1 mg/L), inositol (2.8 and 28 mg/L), L-asparagine (1.33 mM), L-glutamine (2 mM), L-leucine (1.33 mM), L-tyrosine (0.0221 mM), MgCl₂.6H₂O (1 mM), sodium acetate (5 mM), sodium-DL-beta-hydroxybutyrate (2 mM), NAD (10 and 100 mg/L), NH₄Cl (1 mM), para-aminobenzoic acid (2 mg/L), potassium iodide (4.7 mg/L), pyridoxine (0.2 and 2 mg/L), riboflavin (3 mg/L), thiamine (1 mg/L), and uracil (0.1 mg/L)

(IX) Compounds with no effect (between 95.00% and 105.00%) on the growth yield and a positive effect (greater than 105.00%) on the growth rate. This category comprises CaCl₂.2H₂O (0.3 mM), glycine (2 mM), haemin (50 mg/L), L-alanine (2 mM), L-histidine (2 mM), L-proline (2 mM), sodium L-lactate (5 mM), NaHCO₃ (2 mM), para-aminobenzoic acid (0.2 mg/L), and riboflavin (0.3 mg/L). These compounds should be added to the medium composition if the growth rate is to be improved without affecting the growth yield.

### Example 4

### Stoichiometric Model-Based Design of a Fermentation Medium for Improved Growth Rate

From an applied perspective, kinetic properties of biological systems are of primary importance in order to be able to design fermentation processes. For instance, growth kinetics—which is determined by the kinetics of individual reactions in the system—determines process time. Similarly, in fermentations aimed at producing a protein (whether homologous or recombinant), the dynamic behavior of protein expression in response to the changing environment of fermentation processes, directly determines the quantity of the target protein.

Genome-scale metabolic models only contain stoichiometric information, and can therefore only be used for predicting and/or optimizing yields. This is achieved through methods collectively known as constraint-based modeling, in which a set of constraints is applied to the model so that the range of possible solutions (i.e. possible network states or flux distributions) is narrowed down to solutions that meet all constraints. One such method is flux balance analysis (FBA), which further optimizes an objective (typically, maximization of the biomass yield) within the constrained solution space. For example, this method can be used for determining a medium composition (ratio between substrates) which results in optimal biomass yield. However, in the absence of kinetic information, reaction rates cannot be computed. Similarly, gene expression regulation, another kinetic property of biological systems, is typically not included in such models, and can therefore also not be predicted or taken into account during model-based yield optimization. Indeed, the construction of genome-scale kinetic models is currently limited by the availability and quality of information about the kinetic properties of individual enzymatic reactions in the model (Chakrabarti et al., Biotechnol. J. 8:1043-1057 (2013)). As a consequence, growth rates or recombinant protein production rates, for instance, cannot be taken into account in optimization strategies.

Purely stoichiometric genome-scale models are thus well suited for yield optimization, but inherently lack critical information required for rate optimization. Nevertheless, rate optimization can be taken into account in the form of constraints, by further restricting the space of possible solutions to those that meet the desired rate criteria.

Such a method was applied to predict an improved medium formulation based on the de novo minimal CDM of example 2, in which the growth rate would be higher while maintaining a high growth yield. Practically, FBA was performed to maximize the growth yield (biomass production) under a set of constraints reflecting (i) the composition of the de novo minimal CDM and (ii) the effect of individual substrates on the growth rate, as based on the high-throughput assay in example 3 (i.e. for each substrate, the maximum uptake flux was defined as the maximum concentration showing a non-negative impact on the growth rate, thus favoring substrates with a positive impact on the growth rate over those with a negative impact). The resulting medium composition is shown in Table 4.

A 20 L-scale fermentation was performed in the Improved CDM, under the same conditions as described in example 2, except that phosphoric acid 50% (w/v) rather than acetic acid 50% (w/v) was used for pH regulation. The main data are summarized in Table 5. The biomass yield (final biomass concentration) was not different between the two media; the growth rate, however, was significantly higher in the Improved CDM, as reflected by a shorter average generation time.

This example demonstrates that kinetic properties such as the growth rate can be optimized with purely stoichiometric models, by incorporating knowledge about such properties in the form of constraints.

TABLE 4
Composition of de novo minimal CDM and
Improved CDM. All values in mg/L.

| | de novo | |
|---|---|---|
| Compound | minimal CDM | Improved CDM |
| Na-L-Glutamate | 20,000 | 19,845 |
| L-Glutamic acid | 1,600 | 3,479 |
| L-Cysteine HCl | 0 | 4 |
| L-Alanine | 0 | 2,076 |
| L-Aspartic acid | 0 | 524 |
| L-Histidine | 0 | 47 |
| Glycine | 0 | 149 |
| L-Leucine | 0 | 438 |
| L-Methionne | 0 | 116 |
| L-Serine | 0 | 245 |
| L-Tryptophane | 0 | 476 |
| Reduced glutathione (GSH) | 400 | 233 |
| KH₂PO₄ | 500 | 365 |
| KCl | 200 | 274 |
| MgCl₂•6H₂O | 100 | 1,000 |
| CaCl₂•2H₂O | 20 | 20 |
| Fe(III)citrate•3H₂O | 10 | 20 |
| Niacin | 4 | 6 |
| CuCl₂•2H₂O | 0 | 1.28 |
| CoCl2•6H₂O | 0 | 0.42 |
| ZnCl2 | 0 | 10 |
| Dimethyl-beta-cyclodextrin | 1,000 | 1,000 |
| Ascorbic acid | 1,070 | 623 |
| Tris | 6,100 | 0 |
| MOPS | 0 | 2,500 |
| Thiamine HCl | 0 | 10 |
| Biotin | 0 | 0.2 |
| Riboflavin | 0 | 0.3 |
| Ca pantothenate | 0 | 4 |

TABLE 5
Main fermentation parameters for B. pertussis cultivated in de novo minimal
CDM or in Improved CDM

| | COQ369 | COQ502 |
|---|---|---|
| Medium | de novo minimal CDM | Improved CDM |
| Initial biomass (OD₆₅₀ₙₘ)* | 0.066 | 0.119 |
| Final biomass (OD₆₅₀ₙₘ) | 7.7 | 8.0 |
| Total fermentation time** | 280 h12 | 43 h00 |
| Average generation time*** | 40.8 h | 7.1 h |

*Initial biomass concentration calculated based on measured OD₆₅₀ₙₘ of the pre-culture, i.e. 1.5*OD_{pre-culture}/11.5.
**The total fermentation time is defined as the time at which oxygen consumption decreases (as a consequence of glutamate exhaustion), resulting in a decrease in stirring speed.
***Average generation time calculated as follows. First, the number of generations is calculated as the ratio between OD₆₅₀ₙₘ at the end of fermentation and OD₆₅₀ₙₘ at the calculated start of fermentation, converted to log₂. The average generation time is then by dividing the total fermentation time by the number of generations.

### Example 5

### Stoichiometric Model-Based Design of a Fermentation Medium for Improved PT Production

The production of pertussis toxin (PT) by Bordetella pertussis is regulated at the gene expression level through the BvgAS two-component system. Inhibitors of PT production (referred to as bvg modulators) have been widely studied. Among bvg modulators, sulfate is one of the most potent. Yet, sulfate is part of most B. pertussis media, and in addition, it is an end-product of the catabolism of cysteine, which is also included in most B. pertussis media.

A genome-scale stoichiometric metabolic model of B. pertussis was constructed, and used to optimize an existing medium composition for improved PT production, by using an FBA-based strategy. Since reactions for PT production were not included in the model, biomass production was used as an objective function to be maximized by FBA. Constraints were imposed on exchange fluxes only. For compounds present in the existing medium, exchange reactions were constrained to allow uptake of the corresponding substrate at twice the concentration that was actually used by cells in reference cultures used to calibrate the model. No constraint was set on the production of these compounds. For compounds not present in the existing medium, no uptake was allowed, but no constraint was set on maximum production, except for sulfate, sulfite, and sulfur dioxide, whose production was not allowed. Finally, biomass production was constrained exactly to the value measured in the reference fermentations. FBA was performed to maximize biomass production under this set of constraints, while minimizing the flux through all reactions of the network, in order to avoid unnecessary substrate consumption through futile cycles. The deduced medium composition did not contain sulfate and contained approximately 10-fold less cysteine compared to the existing medium. It supported similar biomass production, with a 2.2-fold higher PT yield.

The strategy was repeated using a slightly different set of constraints, in which cysteine was not allowed to be taken up. The deduced medium composition did not contain cysteine at all, which was replaced by thiosulfate. In this medium, similar biomass yields were obtained, and PT production was 2.4-fold higher compared to the existing medium.

This example demonstrates that kinetic properties related to the regulation of gene expression can be optimized with purely stoichiometric models, by incorporating knowledge about such properties in the form of constraints.

1. A method for identifying culture conditions for a cell, the method comprising:
(a) obtaining a genome scale stoichiometric metabolic model of the cell and
(b) performing constraint based optimisation on the metabolic model of the cell using at least one yield based constraint, wherein the yield based constraint promotes a condition that promotes a kinetic parameter and/or suppresses a condition that inhibits a kinetic parameter, and
(c) identifying culture conditions that improve the yield and/or the kinetic parameter of said cell in culture.

2. A method according to claim 1, wherein the kinetic parameter is a rate, such as growth rate, protein production rate, antigen production rate, or the rate of gene expression.

3. A method according to claim 1 wherein the condition that promotes a kinetic parameter or that inhibits a kinetic parameter is selected from a compound or set of compounds, oxygen supply, carbon dioxide supply, proton availability, or any combination thereof.

4. A method according to claim 1 wherein the condition that promotes a kinetic parameter or that inhibits a kinetic parameter is an absolute amount or concentration of a compound or set of compounds, oxygen supply, carbon dioxide supply, or proton availability, or any combination thereof.

5. A method according to claim 1 wherein the condition promotes the kinetic parameter, without any negative effect on yield.

6. A method according to claim 1 wherein the condition promotes the kinetic parameter, and the yield.

7. A method according to claim 1wherein the kinetic parameter is growth rate of the cell.

8. A method according to claim 1 wherein the condition is applied to a minimal chemically defined medium.

9. A method according to claim 1 wherein the kinetic parameter and/or the yield is measured in comparison to a minimal chemically defined medium.

10. A method according to claim 1 wherein the cell is a single celled organism or a cultured eukaryotic cell.

11. A method according to claim 10 wherein the cell is B. pertussis.

12. A method according to claim 11 wherein the cell is selected from the group consisting of B. pertussis, B. bronchiseptica and B. parapertussis.

13. A method according to claim 11 wherein the yield based constraint promotes a condition as promoting that promotes growth rate without any negative effect on yield and wherein the condition is the presence of a compound selected from CaCl₂.2H₂O, glycine, haemin, L-alanine, L-histidine, L-proline, sodium L-lactate, NaHCO₃, para-aminobenzoic acid, and riboflavin.

14. A method according to claim 11 wherein the yield based constraint promotes a condition that promotes both growth rate and yield and wherein the condition is the presence of a compound selected from biotin, glycine, L-alanine at 20 mM), L-arginine, L-cysteine, L-methionine, L-proline, MgCl₂.6H₂O, NaHCO₃, and thiamine.

15. A method according to claim 1 further comprising growing the cell in culture under said identified culture conditions.

16. A method according to claim 15 further comprising measuring growth parameters, and applying said growth parameters so obtained to further optimise the model.

17. (canceled)

18. A method according to claim 15, further comprising the step of recovering from the culture, cells or a product obtained therefrom.

19. A method according to claim 18, further comprising the step of formulating a product obtained from the cells with at least one further antigen.

20. A system comprising:
a processor; and
a memory arranged to store computer executable instructions which, when executed, cause the processor to perform constraint based optimisation on a metabolic model of a cell using at least one yield based constraint, wherein the yield based constraint promotes a condition that promotes a kinetic parameter and/or suppresses a condition that inhibits a kinetic parameter, so as to improve the both yield and/or the kinetic parameter of said cell in culture.

21. A system according to claim 20 wherein the kinetic parameter is selected from one of growth rate, rate of metabolite production, rate of consumption, rate of gene expression, rate of recombinant protein production or rate of recombinant protein secretion.
